(19) United States
(12) Patent Application Publication
(10) Pub. No.: US 2005/0212645 A1
(43) Pub. Date: Sep. 29, 2005

(54) Ignition coil core assembly having C-shaped laminations

(75) Inventors: James John Klocinski, Saline, MI (US); Robert Charles Bauman, Brighton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/811,416

(22) Filed: Mar. 26, 2004

(51) Int. Cl. H01F 27/24

(52) U.S. Cl. 336/234

(57) ABSTRACT

A core assembly for an ignition coil in an internal combustion engine generally includes an inner core comprising an I-shaped lamination and an outer core comprising a pair of opposing C-shaped lamination stacks. A joint is formed by an end of the I-shaped lamination stack and a pair of adjacent ends of the pair of C-shaped lamination stacks. The core assembly is designed in a manner which minimizes the waste material that is scrapped when forming the lamination stacks, as well as allows the inner lamination stack to be slid down along the inner periphery of the outer stack.

### FIELD OF THE INVENTION

The present invention relates generally to ignition coils, and more particularly relates to construction of the core portion of the ignition coil which carries the magnetic flux.

### BACKGROUND OF THE INVENTION

Ignition coils for internal combustion engines generally comprise a core assembly on which a coil assembly is mounted, all of which is contained inside a plastic housing. The coil assembly includes a primary coil concentrically mounted within a secondary coil, and an electric current is flowed through the primary coil creating a large magnetic field. This magnetic field is guided by the core assembly, which is typically constructed of steel lamination stacks. At the proper time in the engine operating cycle, the electric current is abruptly interrupted, and the rapid change in the magnetic field induces a voltage in the secondary coil sufficiently high to create a spark across gapped electrodes of a spark plug attached to the ignition coil.

In one design of ignition coils, the core assembly is formed of an inner core or I-shaped lamination stack that resides inside the primary and secondary windings. There is also an outer core or O-shaped lamination stack, which completely encircles the primary and secondary windings and provides a flux path around the windings so that the magnetic flux is linked to both of the windings. The combination of the I-shaped lamination stack and the O-shaped lamination stack combine to form a figure eight or B-shaped core assembly.

One drawback of this ignition coil design is that there is a waste in material during the manufacture of the lamination stack. Individual laminations are typically cut or sheared and stacked in the stamping operation. For an O-shaped lamination, the center of the O-shape is wasted and scrapped, resulting in relatively small percentage of the steel material actually being used in the core assembly.

Another problem with this ignition coil design is the difficulty of assembly. In particular, the opposing ends of the I-shaped lamination stack are slid inside of the O-shaped lamination stack. However, in order to slide the inner core inside of the outer core, there cannot be a line-to-line fit at the joints formed between the inner and outer cores. This is because a sufficient clearance must be designed in order to allow assembly of the inner and outer cores. At the same time, the I-shaped lamination stack can be difficult to slide down along the inner periphery of the O-shaped lamination stack.

Accordingly, there exists a need to provide a core assembly which reduces the waste in manufacturing of the stack, and also which allows the inner core to be slid down across the interior surface of the outer core during assembly.

### BRIEF SUMMARY OF THE INVENTION

One embodiment of the present invention provides a core assembly for an ignition coil in an internal combustion engine which allows the core to be formed in a manor which minimizes the waste material that is scrapped when forming the lamination stacks, as well as allows the inner lamination stack to be slid down along the inner periphery of the outer stack. The core assembly generally includes an inner core and an outer core. The inner core comprises an I-shaped lamination stack defining a core axis. The outer core comprises a pair of opposing C-shaped lamination stacks. The inner core has first and second opposing free ends, while each C-shaped lamination stack has a third free end and a fourth free end. A first joint is formed by the first end of the I-shaped lamination stack and a pair of third ends of the pair of C-shaped lamination stacks. A second joint is formed by the second end of the I-shaped lamination stack and a pair of fourth ends of the pair of C-shaped lamination stacks. In the first joint, the third ends abut each other and are generally parallel to the core axis, while the first end abuts the third ends and is generally perpendicular to the core axis. In the second joint, the fourth ends abut each and are generally parallel to the core axis, while the second end abuts the fourth ends and is generally perpendicular to the core axis.

In another embodiment of the core assembly, the second end of the inner core defines an extension portion. Further, each C-shaped lamination stack includes a reduced width portion at its fourth free end. The reduced width portions cooperate to define a notch size to receive the extension portion. The second joint is formed by the second end of the I-shaped lamination stack and the pair of fourth ends of the pair of C-shaped lamination stacks. The extension portion of the second end is positioned in the notch and butts against the reduced width portions of the fourth ends.

According to more detailed aspects, the extension portion preferably has a tapered shape, which may take the form of a triangular shape or a curved shape. For example, the extension portion may be semicircular. The extension portion and the notch extend a distance along the core axis about equal to the width of the outer core. However, the extension portion and notch may extend a distance along the core axis that is less than the width of the outer core. Thus, the notch may extend only a portion of the way through the width of the fourth ends, leaving a portion of the fourth end surfaces abutting along a line parallel to the core axis. The first end of the I-shaped lamination stack preferably has a magnet engaging the third ends of the C-shaped lamination stacks.

In another embodiment of the core assembly, an inner core comprises an I-shaped lamination stack and an outer core comprises a pair of opposing C-shaped lamination stacks. The inner core has first and second opposing free ends, the second end being tapered. Each C-shaped lamination stack has a third and fourth free end, each fourth free end being tapered and cooperating with the other fourth free end to define a notch sized to receive the tapered second end. The opposing C-shaped lamination stacks are pulled apart and pushed back together to allow the inner core to be positioned inside the outer core. The third ends define a first opening and the fourth ends define a second opening when the C-shaped lamination stacks are pulled apart a distance less than the width of the I-shaped lamination stack. The first opening is sized to prevent the first end of the I-shaped lamination stack from entering into the first opening, while the second opening is sized to allow the second end of the I-shaped lamination stack to enter the second opening.

According to more detailed aspects, the tapered fourth ends are pressed against the tapered second end to position the I-shaped lamination stack along the core axis. The second end of the I-shaped lamination stack may have a triangular shape or a semicircular shape. The notch may extend a distance along the core axis that is equal to or less than the width of the outer core.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a plan view of a core assembly constructed in accordance with the teachings of the present invention;

FIG. 2 is a plan view of the stamping arrangement used for forming the lamination stacks forming the core assembly depicted in FIG. 1;

FIGS. 3 and 4 are plan views of an alternate embodiment of the core assembly depicted in FIG. 1, showing the outer core member pulled apart and pressed together, respectively;

FIG. 5 is a plan view of yet another embodiment of the core assembly depicted in FIG. 1; and

FIG. 6 is a plan view of still another embodiment of the core assembly depicted in FIG. 1.

### DETAILED DESCRIPTION OF THE INVENTION

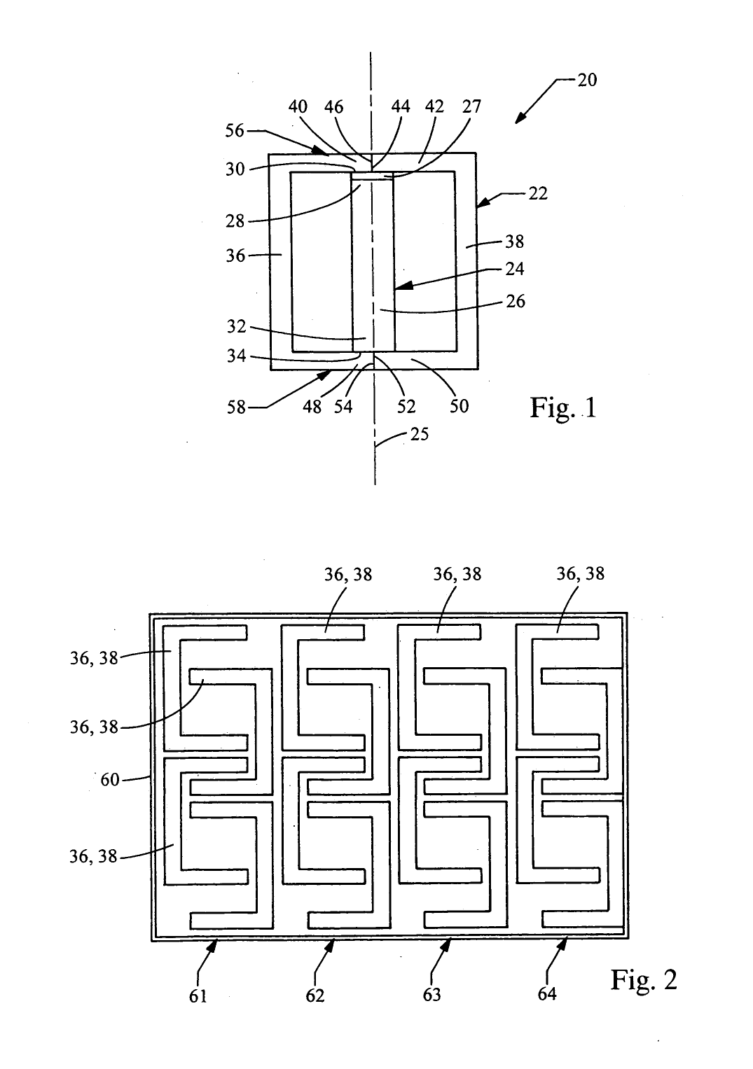

Turning now to the figures, FIG. 1 depicts a plan view of a core assembly 20 constructed in accordance with the teachings of the present invention. The core assembly 20 includes an outer core 22 and an inner core 26. Each of the inner and outer cores 22, 24 are preferably constructed of steel lamination stacks. These steel lamination stacks are constructed by stamping individual laminations out of a sheet of steel, the stampings then being layered to form the lamination stacks. Preferably, the lamination stacks are formed of a silicon steel, although any other material which guides magnetic flux may be used, including solid forms or other non-lamination structures.

The inner core 24 is thus formed as an I-shaped lamination stack 26 defining a core axis 25. The lamination stack 26 includes a first end 28 and an opposing second end 32. The first end 28 defines a first end surface 30 which abuts against the outer core 22, while the second end 32 defines a second end surface 34 which abuts against the outer core 22. The first end 28 may also include a magnet 27, or other material which serves as an air gap between the inner core 24 and the outer core 22, as is well known in the art.

The outer core 22 is of a novel construction, namely two opposing C-shaped lamination stacks 36, 38. The C-shaped lamination stacks 36, 38 are arranged as is shown in FIG. 1 (i.e. mirrored) to form an annular shape surrounding the inner core 24. Each C-shaped lamination stack 36, 38 includes a third free end 40, 42 and a fourth free end 48, 50. The third free ends 40, 42 define end surfaces 44, 46 which abut each other along the line parallel to and aligned with the core axis 25. Similarly, the fourth ends 48, 50 each define ends surfaces 52, 54 which abut along a line generally parallel to and aligned with the core axis 25.

Stated another way, a first joint 56 is formed by the pair of third ends 40, 42 of the pair of C-shaped lamination stacks 36, 38, as well as the first end 28 of the I-shaped lamination stack 26. The first end 28 and its end surface 30 abuts against the third ends 40, 42 (and in particular the inner periphery of the outer core 22) along a line that is generally perpendicular to the core axis 25. Similarly, a second joint 58 is formed by the fourth free ends 48, 50 of the C-shaped lamination stacks 36, 38, and the second end 32 of the I-shaped lamination stack 26 whose end surface 34 abuts against the fourth ends 48, 50 along the line generally perpendicular to the core axis 25.

By forming the outer core 22 of two opposing C-shaped lamination stacks 36, 38, the scrap waste during formation of the lamination stacks 36, 38 is significantly reduced, as will be discussed with reference to FIG. 2. In the figure, a plan view of a steel sheet 60 is provided showing the stamping patterns thereon. As the C-shaped laminations 36, 38 are identically shaped, there need not be any left/right or other designations to distinguish between the two. By virtue of their C-shape, four columns 61, 62, 63, 64 may be formed on a single sheet 60 of steel, each row containing four laminations 36, 38. The stamping pattern results in nearly half of all the material being used for the steel lamination stacks 36, 38, which reflects a 40% to 50% improvement over prior stamping patterns.

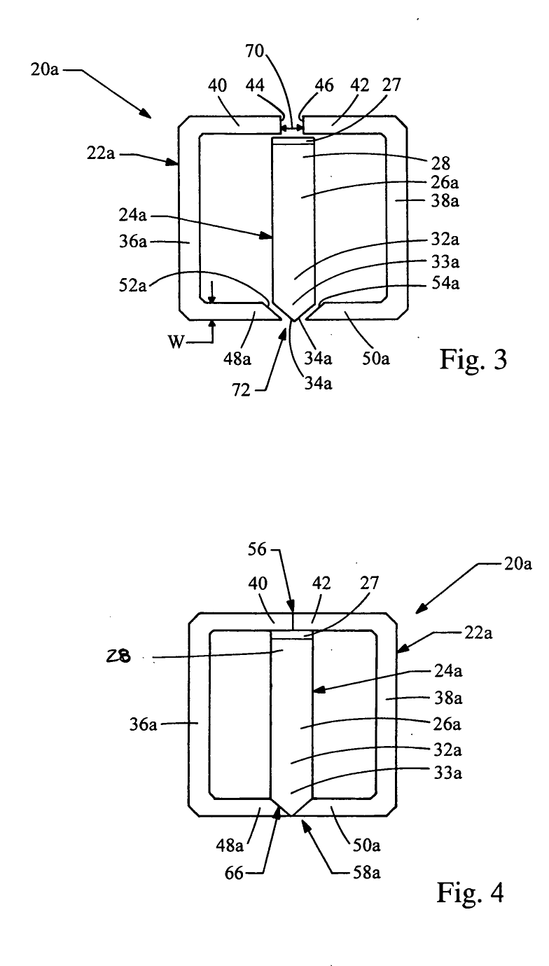

With reference to FIGS. 3 and 4, another embodiment of the core assembly 20a has been depicted in plan view. Like parts have been given like reference numerals in order to aid in the understanding of the invention. In this embodiment, the inner core 24a and its I-shaped lamination stack 26a has been formed with an alternatively shaped second end 32a. In particular, the second end 32a has been formed with an extension portion 33a which defines an extension end surface 3a. As shown in FIGS. 3 and 4, the extension portion 33a has a narrowing shape that is triangular in nature. The extension portion 33a extends an axial distance that is approximately equal to a width W of the outer core 22a.

The opposing C-shaped lamination stacks 36a, 38a also include fourth ends 48a, 50a which have been alternatively shaped, and in particular are narrowing in nature. Stated another way, the fourth ends 48a, 50a include a reduced width portion which define end surfaces 52a, 54a for engaging the second end 32a of the inner core 24a. In particular, the end surfaces 52a, 54a are sloped at an angle that corresponds with the slope of the extension end surface 34a to receive the same. Thus, a second joint 58a is formed by the second end 33a of the I-shaped lamination stack 26a and the fourth ends 48a, 50a of the C-shaped lamination stacks 36a, 38a.

As best seen in FIG. 3, the C-shaped lamination stacks 36a, 38a may be pulled slightly apart to define a first opening 70 between the first ends 40, 42, and a second opening 72 between the second ends 48a, 50a. By including the tapered extension portion 33a on the second end 32a of the inner core 24a, the extension portion 33a may enter into the second opening 72 allowing the inner core 24a to move downwardly along the core axis 25. However, the first end 28 of the inner core 24a is not sized to pass through the first opening 70 formed between the first ends 40, 42. In this way, when the opposing C-shaped lamination stacks 36a, 38a are pressed inwardly towards each other, as shown in FIG. 4, the sloped end surfaces 52a, 54a of the fourth ends 48a, 50a press against the surface 34a of the extension portion 33a to axially position the inner core 24a along the core axis 25. Specifically, this allows the inner core 24a to have its first end 28 pressed firmly against the first ends 40, 42 for forming the first joint 56. Similarly, the reduced width portions at the fourth ends 48a, 50a cooperate to define a notch 66 which is sized to receive the extension portion 33a located at the second end 32a of the I-shaped lamination stack 26a.

Accordingly, it will be recognized by those skilled in the art that a slightly pulling apart of the C-shaped lamination stacks 36a, 38a of the outer core 22a permits some axial adjustability of the inner core 24a, allowing the inner core 24a to be slid downwardly inside of the outer core 22a without any interference from the inner periphery of the outer core 22a.

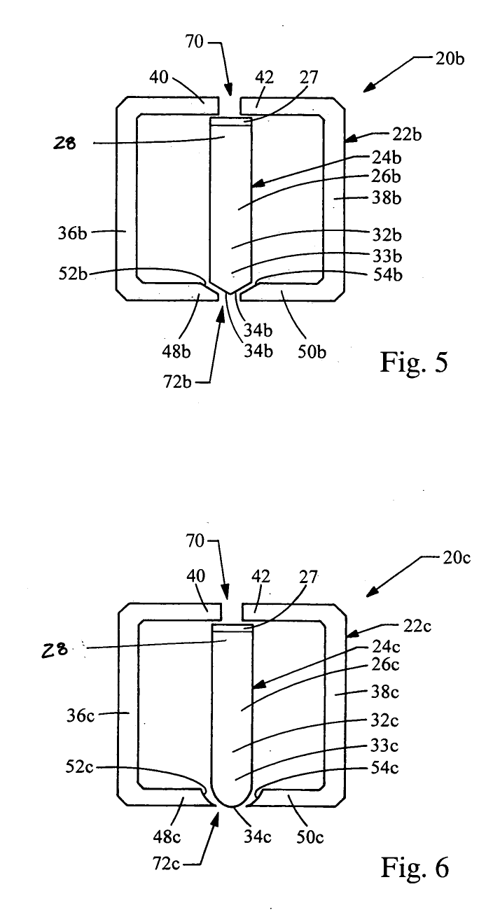

As will be recognized by those skilled in the art, numerous modifications of the extension portion 33a on the second end 32a of the inner core 26a, 24a will be readily envisioned, including corresponding shapes for the notch 66 formed by the fourth ends 48a, 50a of the outer core 22a. For example, as shown in FIG. 5, the second end 32b of the I-shaped lamination stack 26b can include a tapered extension portion 33b which includes a less severe taper than in the prior embodiment depicted in FIGS. 3 and 4. Stated another way, the extension portion 33b extends an axial distance that is less than a width W of the outer core 22b.

Similarly, the fourth ends 48b, 50b of the opposing C-shaped lamination stacks 36b, 38b include reduced width portions defining end surfaces 52b, 54b which corresponds with the extension end surface 34b. It will also be recognized that the end surfaces 52b, 54b will directly contact each other along the outer portion of the width of the outer core 22b and abut each other along the line extending parallel to the core axis 25. When the opposing C-shaped lamination stacks 36b, 38b are pulled apart as shown in FIG. 5, the second opening 72b is sized and oriented to permit entry of the I-shaped lamination stack 26b, and in particular the extension portion 33b for axial positioning of the inner core 24b.

A final example is depicted in FIG. 6, where the second end 32c of the I-shaped lamination stack 26c includes an extension portion 33c which is curved, and in particular has a semicircular shape. Likewise, the fourth ends 48c, 50c of the opposing C-shaped lamination stacks 36c, 38c include reduced width portions which define fourth end surfaces 52c, 54c. The fourth end surfaces 52c, 54c are sized and shaped to correspond with the extension end surface 34c found at the second end 32c of the inner core 24c. Again, the second opening 72c formed between fourth ends 48c, 50c is sized to permit entry of the inner core 24c and allow the inner core 24c to be slid inside the outer core 22c, and then be axially positioned along the core axis 25 such that the first end 28 and magnet 27 are firmly pressed against the third ends 40, 42 of the outer core 22c.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A core assembly for an ignition coil in an internal combustion engine, the core assembly comprising:
an inner core comprising an I-shaped lamination stack defining a core axis;
an outer core comprising a pair of opposing C-shaped lamination stacks;
the inner core having first and second opposing free ends, the second end defining an extension portion;
each C-shaped lamination stack having a third free end and a fourth free end, each fourth free end having a reduced width portion, the reduced width portions cooperating to define a notch sized to receive the extension portion;
a first joint formed by the first end of the I-shaped lamination stack and the pair of third ends of the pair of C-shaped lamination stacks, the third ends abutting each other and being generally parallel to the core axis, the first end abutting the third ends and being generally perpendicular to the core axis; and
a second joint formed by the second end of the I-shaped lamination stack and the pair of fourth ends of the pair of C-shaped lamination stacks, the extension portion of the second end positioned in the notch and abutting against the reduced width portions of the fourth ends.

2. The core assembly of claim 1, wherein the extension portion has a tapered shape.

3. The core assembly of claim 1, wherein the extension portion has a triangular shape.

4. The core assembly of claim 1, wherein the extension portion has a curved shape.

5. The core assembly of claim 4, wherein the extension portion is semicircular.

6. The core assembly of claim 1, wherein the extension portion and notch extend a distance along the core axis about equal to the width of the outer core.

7. The core assembly of claim 1, wherein the extension portion and notch extend a distance along the core axis less than the width of the outer core.

8. The core assembly of claim 1, wherein the notch extends only a portion of the way through the width of the fourth ends leaving a portion of the fourth end surfaces abutting along a line parallel to the core axis.

9. The core assembly of claim 1, wherein the first end of the I-shaped lamination stack has a magnet engaging the thirds ends of the C-shaped lamination stacks.

10. The core assembly of claim 1, wherein the first end of the I-shaped lamination stack abuts the third ends of the C-shaped lamination stacks along a first joint surface, and wherein the second end of the I-shaped lamination stack abuts the fourth ends of the C-shaped lamination stacks along a second joint surface, the first joint surface being non-parallel to the second joint surface.

11. The core assembly of claim 1, wherein the third ends define a first opening and the fourth ends define a second opening when the C-shaped lamination stacks are positioned apart a distance less than the width of the I-shaped lamination stack, and wherein the first opening is sized to prevent the first end of the I-shaped lamination from entering into the first opening, and wherein the second opening is sized to allow the second end of the I-shaped lamination to enter into the second opening.

12. A core assembly for an ignition coil in an internal combustion engine, the core assembly comprising:
an inner core comprising an I-shaped lamination stack defining a core axis;
an outer core comprising a pair of opposing C-shaped lamination stacks;
the inner core having first and second opposing free ends, the second end being tapered;
each C-shaped lamination stack having a third free end and a fourth free end, each fourth free end being tapered, the fourth free ends cooperating to define a notch sized to receive the tapered second end;
the opposing C-shaped lamination stacks being pulled apart and pushed back together to allow the inner core to be positioned inside the outer core;
the third ends defining a first opening and the fourth ends defining a second opening when the C-shaped lamination stacks are pulled apart a distance less than the width of the I-shaped lamination stack; and
the first opening being sized to prevent the first end of the I-shaped lamination from entering into the first opening, the second opening being sized to allow the second end of the I-shaped lamination to enter into the second opening.

13. The core assembly of claim 12, wherein the tapered fourth ends press against the tapered second end to axially position the I-shaped lamination stack along the core axis.

14. The core assembly of claim 12, further comprising a first joint formed by the first end of the I-shaped lamination stack and the pair of third ends of the pair of C-shaped lamination stacks, the third ends abutting each other and being generally parallel to the core axis, the first end abutting the third ends and being generally perpendicular to the core axis.

15. The core assembly of claim 12, further comprising a second joint formed by the second end of the I-shaped lamination stack and the pair of fourth ends of the pair of C-shaped lamination stacks, the tapered second end positioned in the notch and abutting against the tapered fourth ends.

16. The core assembly of claim 12, wherein the second end of the I-shaped lamination stack has a triangular shape.

17. The core assembly of claim 12, wherein the second end of the I-shaped lamination stack is semicircular in shape.

18. The core assembly of claim 12, wherein the notch extends a distance along the core axis less than the width of the outer core.

19. The core assembly of claim 12, wherein the first end of the I-shaped lamination stack abuts the third ends of the C-shaped lamination stacks along a first joint surface, and wherein the second end of the I-shaped lamination stack abuts the fourth ends of the C-shaped lamination stacks along a second joint surface, the first joint surface being non-parallel to the second joint surface.

20. A core assembly for an ignition coil in an internal combustion engine, the core assembly comprising:
an inner core comprising an I-shaped lamination stack defining a core axis, the inner core having first and second opposing free ends;
an outer core comprising a pair of opposing C-shaped lamination stacks, each C-shaped lamination stack having a third free end and a fourth free end;
a first joint formed by the first end of the I-shaped lamination stack and the pair of third ends of the pair of C-shaped lamination stacks, the third ends abutting each other and being generally parallel to the core axis, the first end abutting the third ends and being generally perpendicular to the core axis; and
a second joint formed by the second end of the I-shaped lamination stack and the pair of fourth ends of the pair of C-shaped lamination stacks, the fourth ends abutting each other and being generally parallel to the core axis, the second end abutting the fourth ends and being generally perpendicular to the core axis.
